(19) United States
(12) Patent Application Publication
(10) Pub. No.: US 2021/0078545 A1
(43) Pub. Date: Mar. 18, 2021

(54) Air Transfer Assembly

(71) Applicant: Robert Kerstetter, Athens, AL (US)

(72) Inventor: Robert Kerstetter, Athens, AL (US)

(21) Appl. No.: 16/575,093

(22) Filed: Sep. 18, 2019

(51) Int. Cl. B60S 5/04

(52) U.S. Cl. CPC B60S 5/043

(57) ABSTRACT

An air transfer assembly for filling a flat tire includes a hose. A first air chuck and a second air chuck are coupled to a first end and a second end of the hose, respectively. The first air chuck and the second air chuck are configured to be coupled to valve stems of a donor tire and a recipient tire, respectively, so that the donor tire is in fluidic communication with the recipient tire. A controller that is operationally coupled to the hose is configured to regulate a flow of air though the hose to attain a target air pressure in the recipient tire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fluid transfer assemblies and more particularly pertains to a new fluid transfer assembly for filling a flat tire.

### (2) Description of Related Art including information disclosed under 37 CFR 1.97 and 1.98.

The prior art relates to fluid transfer assemblies.

### BRIEF SUMMARY OF THE INVENTION

An embodiment of the disclosure meets the needs presented above by generally comprising a hose. A first air chuck and a second air chuck are coupled to a first end and a second end of the hose, respectively. The first air chuck and the second air chuck are configured to be coupled to valve stems of a donor tire and a recipient tire, respectively, so that the donor tire is in fluidic communication with the recipient tire. A controller that is operationally coupled to the hose is configured to regulate a flow of air though the hose to attain a target air pressure in the recipient tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an air transfer assembly according to an embodiment of the disclosure.

FIG. 2 is an in-use view of an embodiment of the disclosure.

FIG. 3 is an isometric perspective view of an alternative embodiment of the disclosure.

### DETAILED DESCRIPTION OF THE INVENTION

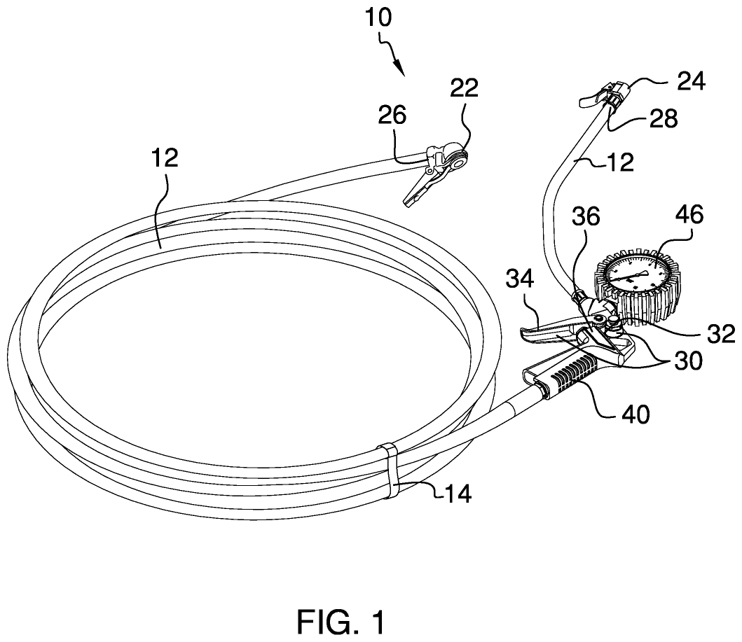

With reference now to the drawings, and in particular to FIGS. 1 through 3 thereof, a new fluid transfer assembly embodying the principles and concepts of an embodiment of the disclosure and generally designated by the reference numeral 10 will be described.

As best illustrated in FIGS. 1 through 3, the air transfer assembly 10 generally comprises a hose 12, which is flexible so that the hose 12 is configured to be positioned in a coiled configuration. The hose 12 has a length of from 2.0 to 10.0 meters.

A fastener 14 is selectively couplable to the hose 12 to fixedly position the hose 12 in the coiled configuration. The fastener 14 may comprise a hook and loop strap 16, or other fastening means, such as zip ties, bungee cords, and the like. The hook and loop strap 16 is loopedly positionable around the hose 12 in the coiled configuration, positioning a first element 18 of the hook and loop strap 16 to be coupled to a second element 20 of the hook and loop strap 16 to fixedly position the hose 12 in the coiled configuration.

A first air chuck 22 and a second air chuck 24 are coupled to a first end 26 and a second end 28 of the hose 12, respectively. The first air chuck 22 and the second air chuck 24 are configured to be coupled to valve stems of a donor tire and a recipient tire, respectively, so that the donor tire is in fluidic communication with the recipient tire. The first air chuck 22 and the second air chuck 24 are closed lock on type so that the first air chuck 22 and the second air chuck 24 are configured to open upon locking to the valve stems of a donor tire and a recipient tire, respectively.

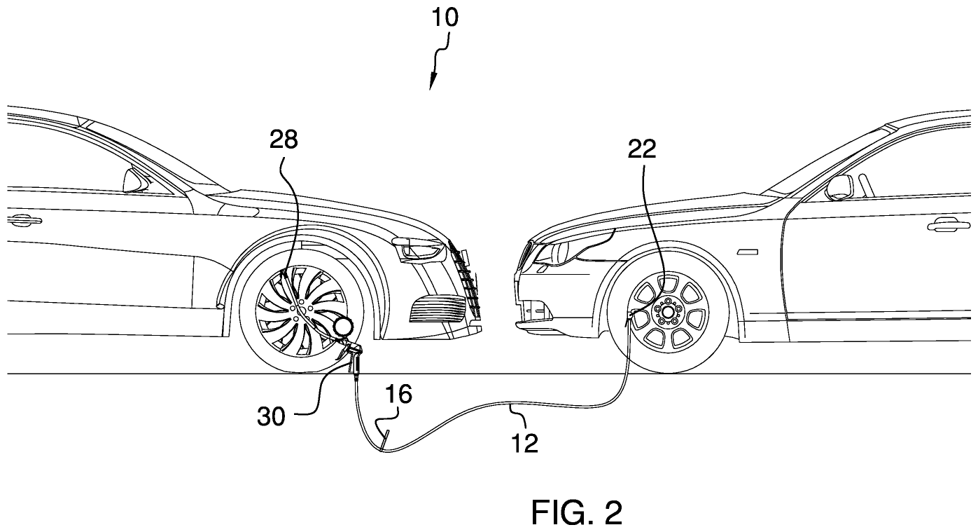

A controller 30 that is operationally coupled to the hose 12 is configured to regulate a flow of air though the hose 12 to attain a target air pressure in the recipient tire. The assembly 10 is anticipated to be useful in situations in which a flat tire is encountered and there is no standard source of compressed air, such as an air compressor. One or more donor tires proximate to the flat tire could be coupled to the flat tire using the assembly 10 to inflate the flat tire, as shown in FIG. 2. A donor tire could be positioned on the same vehicle in the form of installed tires or a spare tire. A donor tire also could be positioned on another vehicle. An ideal situation occurs when the donor tire has a higher recommended pressure and a larger fill volume than the recipient tire, such as using a truck tire as a donor tire to inflate a recipient tire positioned on a passenger vehicle.

The controller 30 may be positioned proximate to the second end 28 of the hose 12 so that a user is positioned to simultaneously manipulate the controller 30 and to view the recipient tire while the recipient tire is being filled.

The controller 30 comprises a valve 32 and an actuator 34. The valve 32 is positioned to selectively close and open the hose 12. The actuator 34 is operationally coupled to the valve 32 so that the actuator 34 is positioned to selectively actuate the valve 32 to regulate the flow of the air through the hose 12.

In one embodiment, as shown in FIGS. 1 and 2, the valve 32 comprises a spring loaded pin 36 and the actuator 34 comprises a trigger 38. The trigger 38 is configured to be selectively depressed to actuate the spring loaded pin 36 to open and close the valve 32. A grip 40 is coupled to the valve 32 proximate to the trigger 38. The grip 40 is configured to be grasped in a hand of the user, positioning the user to selectively depress the trigger 38 with digits of the hand.

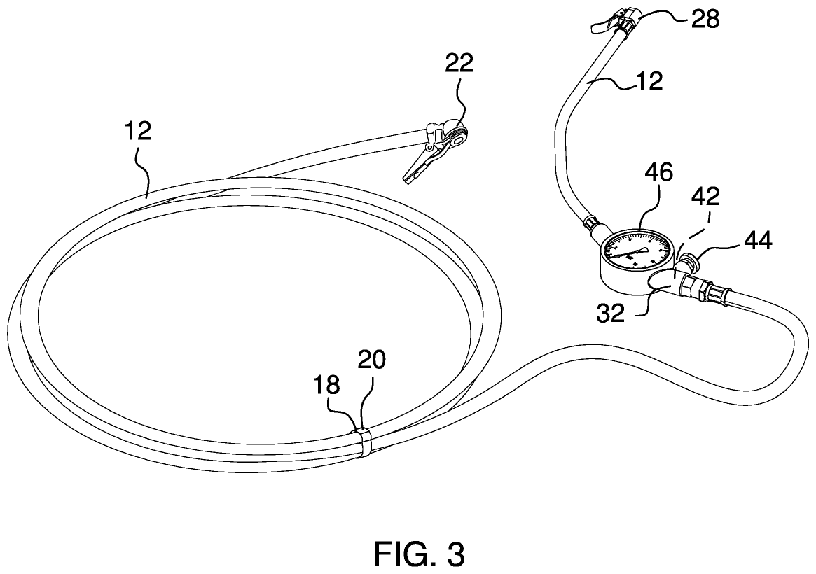

In another embodiment, as shown in FIG. 3, the valve 32 comprises a screw pin 42 and the actuator 34 comprises a knob 44. The knob 44 is configured to be selectively rotated to rotate the screw pin 42 to open and close the valve 32.

A gauge 46 that is operationally coupled to the valve 32 is configured to display a pressure of air in the donor tire. The gauge 46 is at least one of analog dial type, as shown in FIG. 1, analog tube type, and digital type.

The present invention also anticipates the assembly 10 comprising a bag (not shown) in which the other components of the assembly 10 could be stowed. The bag would be selectively sealable and substantially impermeable to water.

In use, the first air chuck 22 is coupled to the valve stem of the donor tire, the hose 12 is extended to the recipient tire, and the second air chuck 24 is coupled to the valve stem of the recipient tire. The trigger 38 is selectively depressed to open the valve 32 so that the air flows through the hose 12 to inflate the recipient tire. The air pressure in the recipient tire can be monitored via the gauge 46. The trigger 38 is released to close the valve 32 when the desired air pressure is reached.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An air transfer assembly comprising:
a hose;
a first air chuck and a second air chuck coupled to a first end and a second end of the hose, respectively, wherein the first air chuck and the second air chuck are configured for coupling to valve stems of a donor tire and a recipient tire, respectively, such that the donor tire is in fluidic communication with the recipient tire; and
a controller operationally coupled to the hose wherein the controller is configured for regulating a flow of air though the hose for attaining a target air pressure in the recipient tire.

2. The assembly of claim 1, further including the hose having a length of from 2.0 to 10.0 meters.

3. The assembly of claim 1, further comprising:
the hose being flexible wherein the hose is configured for positioning in a coiled configuration; and
a fastener selectively couplable to the hose for fixedly positioning the hose in the coiled configuration.

4. The assembly of claim 3, further including the fastener comprising a hook and loop strap such that the hook and loop strap is loopedly positionable around the hose in the coiled configuration positioning a first element of the hook and loop strap for coupling to a second element of the hook and loop strap for fixedly positioning the hose in the coiled configuration.

5. The assembly of claim 1, further including the first air chuck and the second air chuck being closed lock on type wherein the first air chuck and the second air chuck are configured for opening upon locking to the valve stems of a donor tire and a recipient tire, respectively.

6. The assembly of claim 1, further including the controller being positioned proximate to the second end of the hose such that a user is positioned for simultaneously manipulating the controller and viewing the recipient tire.

7. The assembly of claim 1, further including the controller comprising:
a valve positioned for selectively closing and opening the hose; and
an actuator operationally coupled to the valve such that the actuator is positioned for selectively actuating the valve for regulating the flow of the air through the hose.

8. The assembly of claim 7, further including the valve comprising:
a screw pin; and
the actuator comprising a knob wherein the knob is configured for being selectively rotated for rotating the screw pin for opening and closing the valve.

9. The assembly of claim 7, further including the valve comprising:
a spring loaded pin; and
the actuator comprising a trigger wherein the trigger is configured for being selectively depressed for actuating the spring loaded pin for opening and closing the valve.

10. The assembly of claim 7, further including a gauge operationally coupled to the valve wherein the gauge is configured for displaying a pressure of air in the donor tire.

11. The assembly of claim 10, further including the gauge being at least one of analog dial type, analog hose type, and digital type.

12. The assembly of claim 9, further including a grip coupled to the valve proximate to the trigger wherein the grip is configured for grasping in a hand of a user positioning the user for selectively depressing the trigger with digits of the hand.

12. An air transfer assembly comprising:
a hose, the hose being flexible wherein the hose is configured for positioning in a coiled configuration, the hose having a length of from 2.0 to 10.0 meters;
a fastener selectively couplable to the hose for fixedly positioning the hose in the coiled configuration, the fastener comprising a hook and loop strap such that the hook and loop strap is loopedly positionable around the hose in the coiled configuration positioning a first element of the hook and loop strap for coupling to a second element of the hook and loop strap for fixedly positioning the hose in the coiled configuration;
a first air chuck and a second air chuck coupled to a first end and a second end of the hose, respectively, wherein the first air chuck and the second air chuck are configured for coupling to valve stems of a donor tire and a recipient tire, respectively, such that the donor tire is in fluidic communication with the recipient tire, the first air chuck and the second air chuck being closed lock on type wherein the first air chuck and the second air chuck are configured for opening upon locking to the valve stems of a donor tire and a recipient tire, respectively; and
a controller operationally coupled to the hose wherein the controller is configured for regulating a flow of air though the hose for attaining a target air pressure in the recipient tire, the controller being positioned proximate to the second end of the hose such that a user is positioned for simultaneously manipulating the controller and viewing the recipient tire, the controller comprising:
a valve positioned for selectively closing and opening the hose, the valve comprising at least one of a screw pin and a spring loaded pin,
an actuator operationally coupled to the valve such that the actuator is positioned for selectively actuating the valve for regulating the flow of the air through the hose, the actuator comprising at least one of a knob and a trigger wherein the knob is configured for being selectively rotated for rotating the screw pin and the trigger is configured for being selectively depressed for actuating the spring loaded pin for opening and closing the valve,
a gauge operationally coupled to the valve wherein the gauge is configured for displaying a pressure of air in the donor tire, the gauge being at least one of analog dial type, analog hose type, and digital type, and
a grip coupled to the valve proximate to the trigger wherein the grip is configured for grasping in a hand of the user positioning the user for selectively depressing the trigger with digits of the hand.
